(19) United States
(12) Patent Application Publication
(10) Pub. No.: US 2025/0285170 A1
(43) Pub. Date: Sep. 11, 2025

(54) INFORMATION PROCESSING DEVICE AND INFORMATION PROCESSING METHOD

(71) Applicant: TOSHIBA TEC KABUSHIKI KAISHA, Tokyo (JP)

(72) Inventors: Yuya Omiya, Ota Tokyo (JP); Ryuta Fujii, Kashiwa Chiba (JP); Shigeru Sato, Yokohama Kanagawa (JP); Yumiko Okuma, Koganei Tokyo (JP); Naoki Hoshino, Hasuda Saitama (JP)

(21) Appl. No.: 18/951,714

(22) Filed: Nov. 19, 2024

(30) Foreign Application Priority Data
Mar. 8, 2024 (JP) 2024-035910

(51) Int. Cl. G06Q 30/0601; G06Q 30/0251

(52) U.S. Cl. CPC G06Q 30/0641; G06Q 30/0255; G06Q 30/0631

(57) ABSTRACT

An information processing device includes: a specifying unit to specify a customer visiting a store; an acquisition unit to acquire information about a purchased merchandise item of the customer specified by the specifying unit, from a memory device storing information about a purchased merchandise item purchased by each customer in the past; a derivation unit to derive a suggested merchandise item to be suggested to the customer from among merchandise items available for sale at the store, based on the information about the purchased merchandise item acquired by the acquisition unit; a presentation unit to present the suggested merchandise item derived by the derivation unit in a selectable state to the customer via a display device provided at the store; and an output unit configured to, upon accepting a selection of a merchandise item from among the suggested merchandise items, output information about the selected merchandise item to a terminal.

### CROSS-REFERENCE TO RELATED APPLICATION

This application is based upon and claims the benefit of priority from Japanese Patent Application No. 2024-035910, filed on Mar. 8, 2024, the entire contents of which are incorporated herein by reference.

### FIELD

Embodiments described herein relate generally to an information processing device, an information processing method, and a retail store shopping assistant device.

### BACKGROUND

According to the related art, at a retail store dealing in clothing such as an apparel store, a customer service is provided by a store clerk. At such a retail store, a store clerk suggests a combination of clothes suitable for a customer in response to a request by the customer. In other words, a customer service experience personalized for the customer is provided.

However, at a store, there are often cases where a store clerk may not be able to secure a sufficient serving time for each customer. In such cases, the store cannot provide a personalized customer service experience for each customer and this may lead to a loss of sales opportunities.

### DESCRIPTION OF THE DRAWINGS

FIG. 1 is a schematic view showing a schematic configuration of a customer service support system according to an embodiment.

FIG. 2 is a block diagram showing an example of the hardware configuration of a mirror signage.

FIG. 3 is a block diagram showing an example of the hardware configuration of a store server.

FIG. 4 shows an example of the data configuration of a customer information DB.

FIG. 5 shows an example of the data configuration of a fitting room management DB.

FIG. 6 shows an example of the data configuration of a merchandise master.

FIG. 7 is a block diagram showing an example of the functional configuration of the mirror signage.

FIG. 8 shows an example of a screen displayed on the mirror signage.

FIG. 9 shows an example of the screen.

FIG. 10 shows an example of the screen.

FIG. 11 is a block diagram showing an example of the functional configuration of the store server.

FIG. 12 is a sequence chart showing an example of control processing of the customer service support system.

### DETAILED DESCRIPTION

An embodiment described herein is to provide an information processing device and an information processing method that can improve the customer service experience for the customer.

In general, according to one embodiment, an information processing device includes: a specifying unit configured to specify a customer visiting a store; an acquisition unit configured to acquire information about a purchased merchandise item of the customer specified by the specifying unit, from a memory device storing information about a purchased merchandise item purchased by each customer in the past; a derivation unit configured to derive a suggested merchandise item to be suggested to the customer from among merchandise items available for sale at the store, based on the information about the purchased merchandise item acquired by the acquisition unit; a presentation unit configured to present the suggested merchandise item derived by the derivation unit in a selectable state to the customer via a display device provided at the store; and an output unit configured to, upon accepting a selection of a merchandise item from among the suggested merchandise items, output information about the selected merchandise item to a terminal carried by a store clerk.

An embodiment of a customer service support system 1 will now be described with reference to the drawings. In the embodiment described below, an example where the system is applied to an apparel store selling clothing (hereinafter also referred to as the store) is described. However, this embodiment is not limiting. Also, the embodiment described below should not limit the present disclosure. Component elements in the embodiment described below include component elements which a person skilled in the art can easily think of, substantially the same component elements, and component elements in a so-called range of equivalents. Moreover, various omissions, replacements, changes, and combinations of component elements can be made without departing from the scope of the embodiment described below.

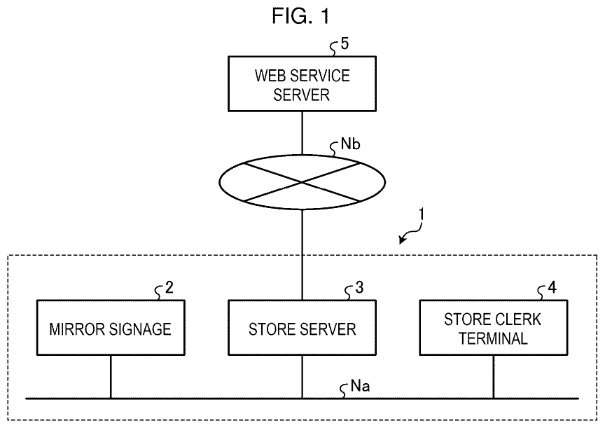

FIG. 1 is a schematic view showing a schematic configuration of the customer service support system 1 according to the embodiment. The customer service support system 1 has a mirror signage 2, a store server 3, a store clerk terminal 4, and a web service server 5.

The mirror signage 2 and the store server 3 are provided, for example, at a store or the like. The mirror signage 2 is installed, for example, in a fitting room in the store, in an aisle in the store, or the like. The store server 3 is provided, for example, at a data center or the like inside the store or outside the store.

The mirror signage 2, the store server 3, and the store clerk terminal 4 are communicably connected to each other via a network Na such as a local area network (LAN). The store server 3 is also communicably connected to the web service server 5 via a network Nb such as the internet. The numbers of these devices connected to the networks Na, Nb are not limited to the illustrated example.

The mirror signage 2 is an example of a display device. For example, as a half mirror is provided at a position facing a display surface of a display provided in the mirror signage 2, the mirror signage 2 reflects the appearance of a customer and also displays a display content on the display visibly to the customer. The mirror signage 2 can also be used simply as a mirror.

The mirror signage 2 displays various screens. Specifically, the mirror signage 2 displays a screen related to the customer service for the customer and a screen including an operator selectable by the customer via an operation unit 209 of the mirror signage 2. For example, the mirror signage 2 displays a screen that notifies the customer of the start of the customer service for the customer. The mirror signage 2 also displays a screen including information about a merchandise item which the customer is recommended to purchase. The mirror signage 2 also displays a screen including information about customer service support (for example, a guide to a fitting room where a merchandise item which the customer can try on, or the like).

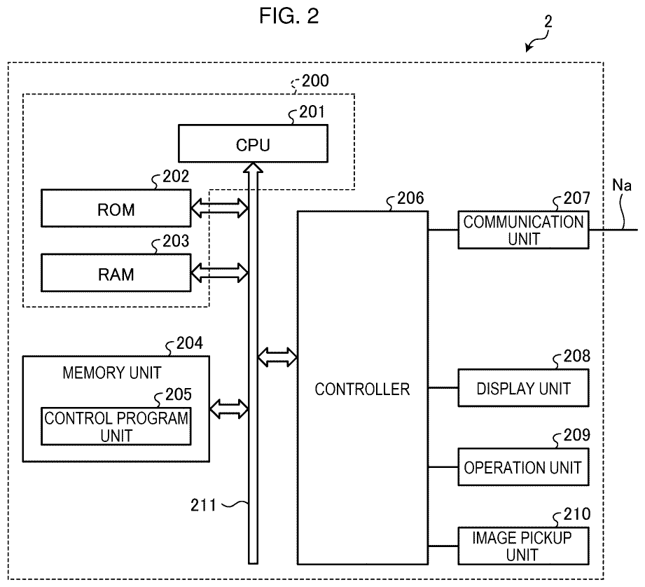

The mirror signage 2 performs authentication processing for the customer to receive a service from the store via the mirror signage 2 (hereinafter simply referred to as authentication processing), in cooperation with the store server 3, described later. Specifically, the mirror signage 2 specifies the customer, based on an image related to the specification of the customer (hereinafter also referred to as a customer image) picked up by an image pickup unit 210 (see FIG. 2) provided in the mirror signage 2, and thus performs the authentication processing. The customer image is, for example, an image of the face of the customer that is picked up.

To describe this more in detail, the mirror signage 2 transmits the customer image picked up by the image pickup unit 210 to the store server 3. Subsequently, the store server 3 extracts a feature from the received customer image and collates the extracted feature with feature data related to the specification of the customer stored in the store server 3. If the feature extracted from the customer image matches the feature data of any customer stored in the store server 3, the store server 3 transmits a notification that notifies that the authentication processing including customer information, described later, is completed normally (hereinafter also referred to as an authentication processing completion notification) to the mirror signage 2. Upon receiving the authentication processing completion notification from the store server 3, the mirror signage 2 displays a message that notifies of the customer information and the start of the customer service at a display unit 208 of the mirror signage 2. As a method for extracting a feature from the customer image, a known and available method can be employed.

For the authentication processing, various methods can be employed. For example, the image pickup unit 210 of the mirror signage 2 may read a code symbol such as a two-dimensional code provided on a store member card and thus may perform the authentication processing to specify the customer, based on a member ID or the like included in this code symbol.

The store server 3 is an example of an information processing device. The store server 3 is, for example, a server device installed in the store. The store server 3 stores the customer information of the customer, information about the state of use of the fitting room, information about the price or the like of a merchandise item, and a program correlated with the generation of a merchandise item to be suggested to the customer, or the like. The merchandise item is, for example, a clothing item (including tops, pants, shoes, accessories, and the like) available for sale at the store. Details of the customer information and the information about the state of use of the fitting room will be described later.

The store server 3 performs the authentication processing in cooperation with the mirror signage 2. The store server 3 may be configured with a plurality of computers. In other words, the functions of the store server 3 may be distributed to a plurality of computers. The store server 3 may be a cloud server installed on a cloud.

The store server 3 performs a series of processes related to the generation and provision of a sales promotion text to be suggested to the customer by a clothing item suggestion LLM 309 stored in the store server 3, described later (hereinafter also referred to as clothing item suggestion processing). Details of the sales promotion text and the clothing item suggestion processing will be described later.

The store clerk terminal 4 is, for example, a terminal device such as portable terminal like a tablet terminal, a wearable terminal or a smartphone carried by the store clerk of the store. Specifically, the store clerk terminal 4 receives a fitting room number and a suggested clothing item list from the store server 3. The store clerk terminal 4 also transmits a preparation completion notification including the fitting room number of a fitting room whose preparation is completed (hereinafter also referred to as a preparation completion notification) to the store server 3 in response to an operation by the store clerk. Details of the suggested clothing item list will be described later.

The web service server 5 is, for example, a server device installed on a cloud. The web service server 5 provides various services (network services) via the network Nb. For example, the web service server 5, in conjunction with an action of a user using a service, provides a service to manage a clothing item purchased by the user, on a per user basis.

Specifically, the web service server 5 stores a closet database related to the above service. The closet database is, for example, a database storing user information of a user using the web service server 5 and information about a clothing item purchased by the user (hereinafter also referred to as DB item information), in correlation with each other.

The user information includes, for example, information such as a user ID that can identify each user on a service provided by the web service server 5. The user information may also include identification information such as a member ID that can specify a customer at the store. The DB item information includes information about a clothing item, such as the type, color, size, and brand of the clothing item. The DB item information may also include the date of purchase of the clothing item or the date of registration with the closet database, or the like.

The DB item information stored in the closet database may be about clothing items purchased at a plurality of stores. The DB item information may also be about a clothing item purchased via an online shopping service such as an EC site. The DB item information stored in the closet database is not limited to the clothing item purchased by the user and may be about a clothing item which the user takes interest in or a clothing item taken as a candidate item to be purchased, or the like.

The web service server 5 also provides various information stored in the closet database in the web service server 5 to the store server 3 via the network Nb in response to a request by the store server 3.

The configuration of the forgoing mirror signage 2 will now be described with reference to FIG. 2. FIG. 2 is a block diagram showing an example of the hardware configuration of the mirror signage 2 according to the embodiment. As shown in FIG. 2, the mirror signage 2 has a central processing unit (CPU) 201 as an example of a processor, a read-only memory (ROM) 202, a random-access memory (RAM) 203, and a memory unit 204.

The CPU 201 manages and controls each part of the mirror signage 2. The ROM 202 stores various programs. The RAM 203 is a work space where a program and various data are loaded. The memory unit 204 stores various programs.

The CPU 201, the ROM 202, the RAM 203, and the memory unit 204 are coupled to each other via a bus 211. The CPU 201, the ROM 202, and the RAM 203 form a control unit 200 with a computer configuration. That is, the control unit 200 executes control processing of the mirror signage 2, described later, by causing the CPU 201 to operate according to a control program unit 205 stored in the ROM 202 or the memory unit 204 and loaded in the RAM 203.

The memory unit 204 is a nonvolatile memory such as a hard disk drive (HDD) or a flash memory where stored information is held even when the power is turned off. The memory unit 204 has the control program unit 205.

The control unit 200 is coupled to a communication unit 207, the display unit 208, the operation unit 209, and the image pickup unit 210 via a controller 206 and the bus 211. The communication unit 207 is a communication interface to communicate via the network Na.

The controller 206 is coupled to the communication unit 207, the display unit 208, the operation unit 209, and the image pickup unit 210. The controller 206 controls each connected unit, based on a command from the control unit 200.

The display unit 208 is a display device such as a liquid crystal display (LCD). The display unit 208 displays various information under the control of the CPU 201. The operation unit 209 is a touch panel provided at the display unit 208. The operation unit 209 outputs an operation content inputted via an input device, to the CPU 201. The operation unit 209 may be an input device such as a keyboard or a pointing device. The image pickup unit 210 is an image pickup device having an image pickup element such as a CCD or a CMOS.

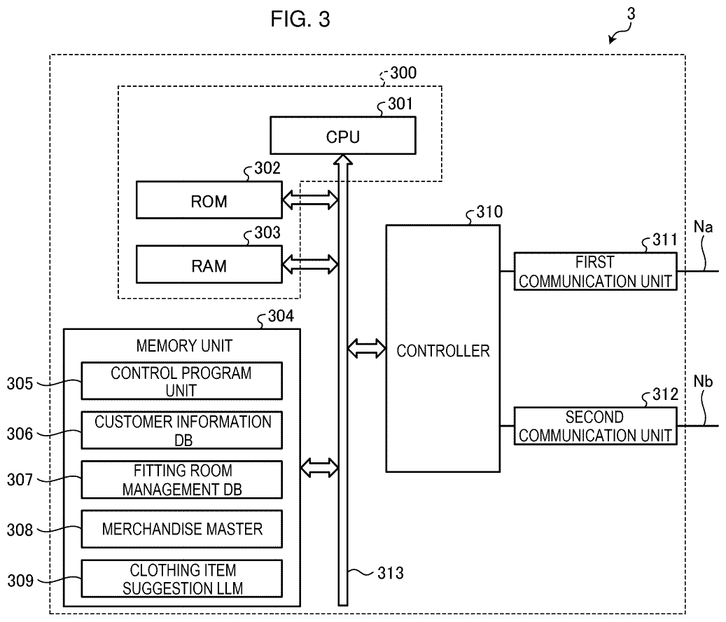

The configuration of the foregoing store server 3 will now be described with reference to FIG. 3. FIG. 3 is a block diagram showing an example of the hardware configuration of the store server 3 according to the embodiment. As shown in FIG. 3, the store server 3 has a CPU 301 as an example of a processor, a ROM 302, a RAM 303, and a memory unit 304.

The CPU 301 manages and controls each part of the store server 3. The ROM 302 stores various programs. The RAM 303 is a work space where a program and various data are loaded. The memory unit 304 stores various programs.

The CPU 301, the ROM 302, the RAM 303, and the memory unit 304 are coupled to each other via a bus 313. The CPU 301, the ROM 302, and the RAM 303 form a control unit 300 with a computer configuration. That is, the control unit 300 executes control processing of the store server 3, described later, by causing the CPU 301 to operate according to a control program unit 305 stored in the ROM 302 or the memory unit 304 and loaded in the RAM 303.

The memory unit 304 is a nonvolatile memory such as an HDD or a flash memory where stored information is held even when the power is turned off. The memory unit 304 has the control program unit 305, a customer information DB 306, a fitting room management DB 307, a merchandise master 308, and the clothing item suggestion LLM 309.

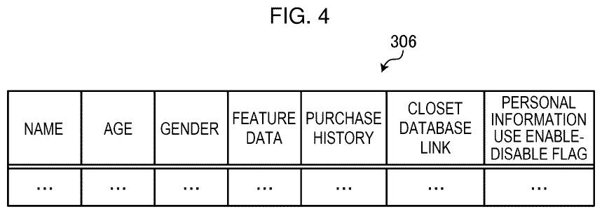

The customer information DB 306 is a data table or a database for the store to manage customer information. FIG. 4 shows an example of the data configuration of the customer information DB 306. As shown in FIG. 4, the customer information DB 306 stores customer information of customers, such as the name, age, gender, feature data, purchase history, closet database link, and personal information use enable-disable flag.

As the feature data, feature data extracted from the customer image is stored. The feature data is acquired by quantifying a feature of the customer image calculated using a known and available technique. If the member card is used for the authentication processing, the member ID or the like held on the member card may be stored as the feature data.

The purchase history is a record of purchase of merchandise items or the like, such as the date and time when the customer purchased a merchandise item at the store managing the customer information DB 306. The closet database link is a link to access the web service server 5 where the closet database link is stored. Accessing the closet database link enables reference to or acquisition of the DB item information of a user who is a customer. If the closet database in the web service server 5 includes the member ID for the store, the DB item information of the corresponding customer is referred to or acquired by accessing the web service server 5 with a designation of the member ID.

The personal information use enable-disable flag is flag information to prescribe whether to enable the use of the personal information of the customer in clothing item suggestion processing, described later. The personal information use enable-disable flag is, for example, binary flag information having the value “1” if the flag is enabled (hereinafter also referred to as an ON-state) and the value “0” if the flag is disabled (hereinafter also referred to as an OFF-state). Specifically, if the personal information use enable-disable flag is enabled, the control unit 300 of the store server 3 accesses a server corresponding to the address stored in the closet database link, that is, the web service server 5, in the clothing item suggestion processing. The control unit 300 of the store server 3 then acquires the DB item information of the corresponding customer from the closet database stored in the web service server 5.

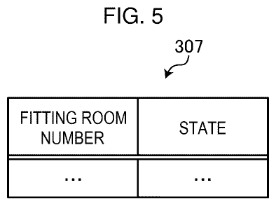

Referring back to FIG. 3, the fitting room management DB 307 is a data table or a database for the store to manage fitting rooms. FIG. 5 shows an example of the data configuration of the fitting room management DB 307. As shown in FIG. 5, the fitting room management DB 307 stores fitting room information in which the fitting room number of a fitting room and the state of use of the fitting room correspond to each other.

The fitting room number is an identifier that can identify each of the fitting rooms installed in the store and is, for example, a room number allocated to each fitting room. The state stored in the fitting room management DB 307 is information representing the state of use of each fitting room. The state stored in the fitting room management DB 307 is, for example, information managed as binary information having the value “1” if the fitting room is in use and the value “0” if the fitting room is vacant and not in use. The fitting room information in the fitting room management DB 307 includes location information of the fitting room in the store.

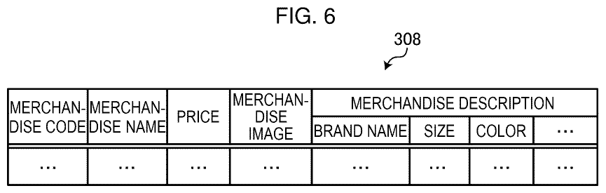

Referring back to FIG. 3, the merchandise master 308 is a data table or a database to manage the price or the like of a merchandise item available for sale at the store. FIG. 6 shows an example of the data configuration of the merchandise master 308. As shown in FIG. 6, the merchandise master 308 stores, in association with a merchandise code that can identify the type of a merchandise item available for sale at the store, merchandise information such as the merchandise name, price, merchandise image, and merchandise description of the merchandise item corresponding to the merchandise code.

The merchandise image is, for example, an image showing a merchandise item. The merchandise description stored in the merchandise master 308 includes, for example, information s the brand name, size, color or the like of a such as merchandise item which is a clothing item, and the storage place of the merchandise item in the store. The merchandise description also includes information indicating a season, environment, event or the like suitable for wearing the item, and information that contributes to the decision to derive the merchandise item to be suggested to the customer.

Referring back to FIG. 3, the clothing item suggestion LLM 309 is generative AI that generates texts, and is a large language model (LLM). The clothing item suggestion LLM 309 is an example of generative AI that learns patterns and relations of data and thus can generate new contents such as images, sentences, voices, and structured data.

The clothing item suggestion LLM 309 is, for example, an LLM that is constructed by a known deep learning technique and that, upon receiving an input of a text designating a condition, outputs a text about a merchandise item based on the condition. For example, the condition is a reference condition that serves as a reference for deriving an output result, or a limiting condition to narrow down an output result.

The clothing item suggestion LLM 309 derives a merchandise item available for sale at the store, based on various conditions inputted thereto, and generates a sales promotion text to promote the sales of the derived merchandise item. The sales promotion text is, for example, text data describing the merchandise name of a clothing item which the customer is recommended to purchase, and the merchandise description of this clothing item. The sales promotion text may be text data in the form of a list including the names of a plurality of clothing items and the description of the plurality of the clothing items.

In this embodiment, an LLM is used as generative AI. However, the generative AI may be any generative AI that can generate a text and is not limited to an LLM. The clothing item suggestion LLM 309 may be configured independently of the store server 3. In other words, the clothing item suggestion LLM 309 may be installed outside the store or on a cloud and may be configured to be able to communicate in response to a request by the store server 3.

The clothing item suggestion LLM 309 in this embodiment generates a sales promotion text for the customer in response to an input of an input sentence generated by a generation processing unit 3003, described later. The input sentence includes information about a merchandise item purchased by the customer in the clothing item suggestion processing, and instruction information giving an instruction to generate a sales promotion text.

The input sentence is generated, for example, in the form of a character string described in a natural language. Specifically, the instruction information includes a character string (hereinafter referred to as a prompt) including the content, format, and information of a sentence to be generated by the clothing item suggestion LLM 309. More preferably, the sentence described by the prompt may explicitly represent the merchandise information of the merchandise item purchased by the customer. It is also preferable that the prompt includes the customer's taste and preference about clothing items of the customer (hereinafter referred to as taste and preference information) or includes a sentence giving an instruction to generate a sales promotion text based on the taste and preference information.

The method for generating the prompt is not particularly limited. For example, the generation processing unit 3003 of the store server 3, described later, may employ a method of generating the prompt, based on a predetermined template. In this case, a plurality of templates corresponding to the genders and age groups of customers may be prepared, and the generation processing unit 3003 may be configured to switch the template to use according to the customer information.

As an example of the prompt, for example, a prompt giving an instruction to generate a sentence including a content correlated with the age of the customer included in the customer information may be inputted to the LLM. Also, for example, a prompt giving an instruction to generate a sentence including a content correlated with a merchandise item recorded in the purchase history included in the customer information may be inputted to the LLM.

The control unit 300 is coupled to a first communication unit 311 and a second communication unit 312 via a controller 310 and the bus 313. The first communication unit 311 is a communication interface to communicate via the network Na. The second communication unit 312 is a communication interface to communicate via the network Nb.

The controller 310 is coupled to the first communication unit 311 and the second communication unit 312. The controller 310 controls each part coupled thereto, based on a command from the control unit 300.

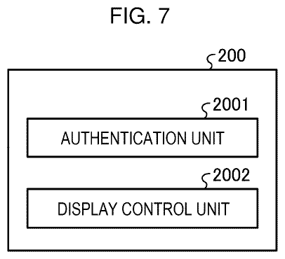

The functional configuration of the control unit 200 of the mirror signage 2 will now be described with reference to FIG. 7. FIG. 7 is a block diagram showing an example of the functional configuration of the mirror signage 2 according to the embodiment. As shown in FIG. 7, the control unit 200 has an authentication unit 2001 and a display control unit 2002, as the functional configuration thereof. However, the functional configuration of the mirror signage 2 is not limited to this.

Specifically, the control unit 200 (CPU 201) of the mirror signage 2 implements the above functional configuration by executing the control program unit 205 stored in the memory unit 204. In this embodiment, the above functional configuration is a software configuration implemented by the cooperation between the processor of the mirror signage 2 and the program. However, this is not limiting. A part or all of the functional configuration may be a hardware configuration implemented by a dedicated circuit or the like.

The authentication unit 2001 performs authentication of a customer, using the image pickup unit 210. Specifically, the authentication unit 2001 acquires a customer image of a customer visiting the store, via the image pickup unit 210. The authentication unit 2001 transmits the acquired customer image to the store server 3. Upon receiving an authentication processing completion notification from the store server 3, the authentication unit 2001 cooperates with the display control unit 2002, described later, and thus causes the display unit 208 to display a message notifying of the start of the customer service. When notifying of the start of the customer service, the authentication unit 2001 may also cause the customer information of a customer whose authentication is successful, to be displayed.

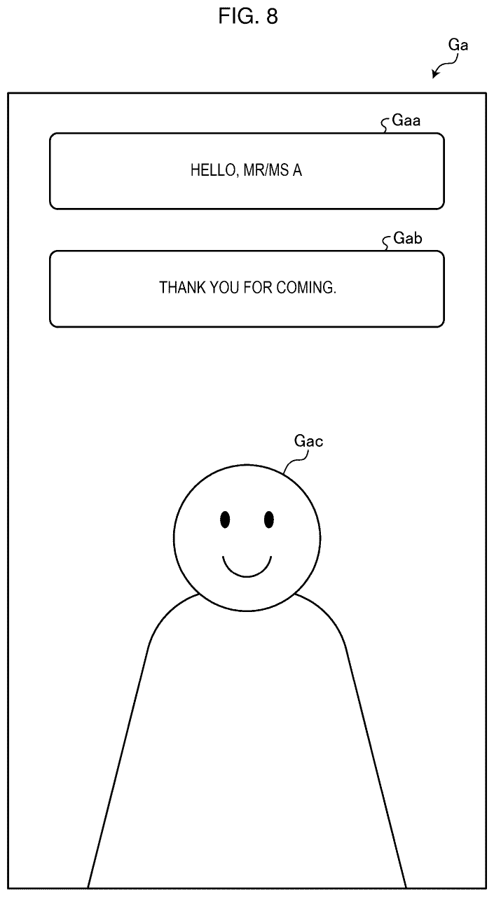

The display control unit 2002 causes the display unit 208 to display various information. Specifically, upon receiving the authentication processing completion notification from the store server 3, the display control unit 2002 causes the display unit 208 to display a message notifying of the start of the customer service as shown in FIG. 8.

FIG. 8 shows an example of the screen displayed on the mirror signage 2. The display control unit 2002 causes the display unit 208 to display a customer service start screen Ga as shown in FIG. 8 in order to notify the customer of the start of the customer service. The customer service start screen Ga includes an area Gaa where the customer information and a message related to the start of the customer service are displayed, an area Gab where a message thanking the customer for visiting the store is displayed, and an area Gac where an avatar with an image of a store clerk is displayed. Also, the display control unit 2002 may be configured not to display the customer information.

If the authentication is not completed normally, for example, if the customer performing the authentication processing is a new customer or the like and is not registered yet with the customer information DB 306, the display control unit 2002 may not cause the mirror signage 2 to display the customer service start screen Ga and may cause the mirror signage 2 to be used simply as a mirror. The display control unit 2002 may cause the mirror signage 2 to display a screen that prompts the customer to perform member registration, instead of causing the mirror signage 2 to display the customer service start screen Ga.

If the authentication processing is completed normally, the store server 3 performs the clothing item suggestion processing. Specifically, the store server 3 acquires the purchase history the customer of specified by the authentication processing and the DB item information. Subsequently, the store server 3 generates a sales promotion text, based on the acquired information and instruction information giving an instruction to suggest a merchandise item. Subsequently, the store server 3 derives a suggested clothing item list, described later, based on the generated sales promotion text. The store server 3 presents the derived suggested clothing item list to the customer via the mirror signage 2 and outputs the merchandise information of a merchandise item selected by the customer from the presented suggested clothing item list, to the store clerk terminal 4.

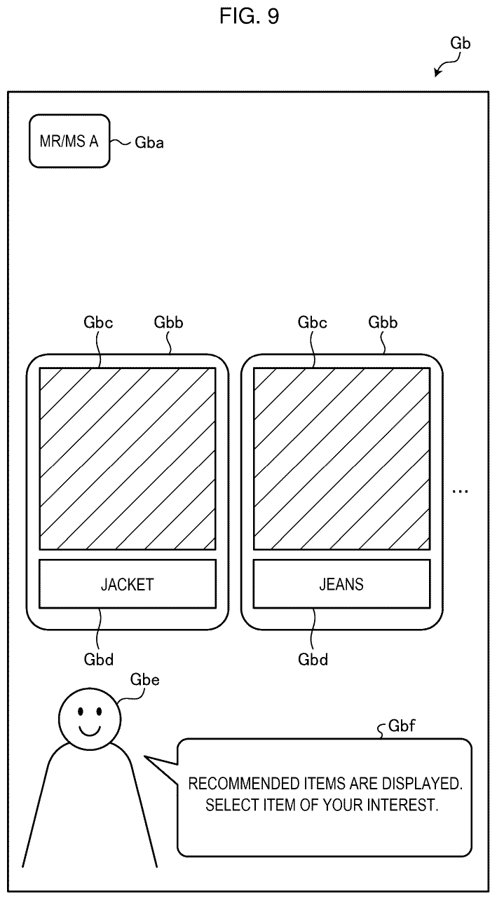

Referring back to FIG. 7, upon receiving the suggested clothing item list from the store server 3, the display control unit 2002 causes the display unit 208 to display the suggested clothing item list in a selectable format via the operation unit 209, as shown in FIG. 9.

FIG. 9 shows an example of the screen displayed on the mirror signage 2. The display control unit 2002 causes the display unit 208 to display a clothing item selection screen Gb as shown in FIG. 9, based on the suggested clothing item list, in order to cause the customer to select a clothing item which the customer himself or herself is interested in. The clothing item selection screen Gb includes an area Gba, an area Gbb, an area Gbc, and an area Gbd, an area Gbe, and an area Gbf.

In the area Gba, the name of the customer is displayed. In the area Gbb, the merchandise information of a merchandise item described in the suggested clothing item list is displayed. Specifically, the area Gbb includes the area Gbc, where a merchandise image of a merchandise item included in the suggested clothing item list is displayed, and the area Gbd, where the merchandise name of a merchandise item included in the suggested clothing item list is displayed. The area Gbb is displayed on a per merchandise item basis included in the suggested clothing item list. FIG. 9 shows an example where two merchandise items with the merchandise names “jacket” and “jeans” are shown. The area Gbd also functions as an operator (operation button), and in response to an operation within the area Gbb, enables the selection of the merchandise information of the merchandise item in the operated area Gbb.

In the area Gbe, an avatar mimicking a store clerk is displayed. In the area Gbf, for example, a message that prompts the customer to select a clothing item displayed on the display unit 208 is displayed.

The number of pieces of merchandise information of merchandise items displayed in one screen is not limited to the illustrated example. If the merchandise information does not fit in one screen, the merchandise information of merchandise items that are not displayed yet may be sequentially displayed in response to a scroll operation in the left-right direction. The clothing item selection screen Gb need not be displayed in such a way as to occupy the entirety of the display unit 208 and may be displayed only in a part of the display unit 208, and the part where the clothing item selection screen Gb is not displayed may be usable as a mirror.

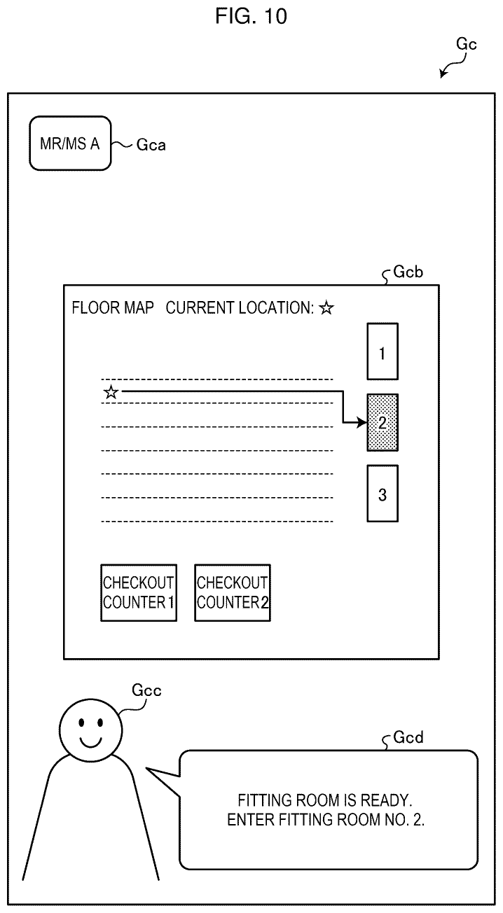

Upon accepting one piece of merchandise information selected by the customer via the operation unit 209 from the merchandise information of the merchandise items displayed on the display unit 208 (clothing item selection screen Gb), the display control unit 2002 transmits the merchandise information of the merchandise item that is selected, to the store server 3. Also, upon receiving a fitting room number from the store server 3, the display control unit 2002 causes the display unit 208 to display a screen that guides the customer to the fitting room, as shown in FIG. 10.

FIG. 10 shows an example of the screen displayed on the mirror signage 2. Upon receiving a fitting room number from the store server 3, the display control unit 2002 causes the display unit 208 to display a fitting room guide screen Gc as shown in FIG. 10 in order to guide the customer to the fitting room. The fitting room guide screen Gc includes an area Gca, an area Gcb, an area Gcc, and an area Gcd.

In the area Gca, the name of the customer is displayed. In the area Gcb, a screen including the current location (place where the mirror signage 2 operated by the customer is installed), the location of the fitting room corresponding to the fitting room number received from the store server 3, and a route guide from the current location to the fitting room, is displayed. In the area Gcc, an avatar mimicking a store clerk is displayed. In the area Gcd, for example, a message that guides the customer to the fitting room is displayed.

As will be described later, in the fitting room corresponding to the fitting room number, the merchandise item selected in the clothing item selection screen Gb is prepared by the store clerk. Therefore, the customer using the mirror signage 2 moves to the indicated fitting room, based on the route guide displayed in fitting room guide screen Gc, and thus can try on the merchandise item selected in the clothing item selection screen Gb.

The fitting room guide screen Gc need not be displayed in such a way as to occupy the entirety of the display unit 208 and may be displayed only in a part of the display unit 208, and the part where the fitting room guide screen Gc is not displayed may be usable as a mirror.

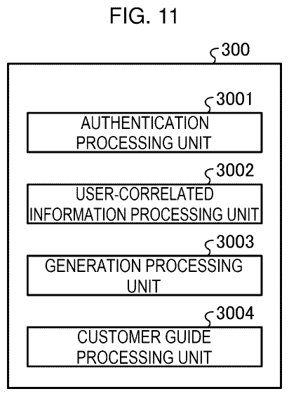

The functional configuration of the control unit 300 of the store server 3 will now be described with reference to FIG. 11. FIG. 11 is a block diagram showing an example of the functional configuration of the store server 3 according to the embodiment. As shown in FIG. 11, the control unit 300 has an authentication processing unit 3001, a user-correlated information processing unit 3002, the generation processing unit 3003, and a customer guide processing unit 3004, as the functional configuration thereof. However, the functional configuration of the store server 3 is not limited to this.

Specifically, the control unit 300 (CPU 301) of the store server 3 implements the above functional configuration by executing the control program unit 305 stored in the memory unit 304. In this embodiment, the above functional configuration is a software configuration implemented by the cooperation between the processor of the store server 3 and the program. However, this is not limiting. A part or all of the functional configuration may be a hardware configuration implemented by a dedicated circuit or the like.

The authentication processing unit 3001 is an example of a specifying unit. The authentication processing unit 3001 specifies a customer visiting the store. Specifically, the authentication processing unit 3001 extracts a feature from the customer image received from the authentication unit 2001 and collates the extracted feature with feature data stored in the customer information DB 306. If the feature extracted from the customer image matches the feature data of any customer stored in the customer information DB 306, the authentication processing unit 3001 specifies that the customer corresponding to the matching feature data is visiting the store. The authentication processing unit 3001 transmits an authentication processing completion notification to the mirror signage 2.

If the authentication processing is not completed normally, that is, if the feature extracted from the customer image does not match the feature data of any customer stored in the customer information DB 306, the authentication processing unit 3001 transmits a message notifying that the authentication processing is not completed normally, to the mirror signage 2.

The user-correlated information processing unit 3002 is an example of an acquisition unit and an extraction unit. The user-correlated information processing unit 3002 acquires information about a merchandise item purchased by the customer specified by the authentication processing unit 3001. The information about the purchased merchandise item is the purchase history of the customer and the DB item information stored in the closet database.

Specifically, the user-correlated information processing unit 3002 accesses the closet database link of the customer stored in the customer information DB 306 and acquires the DB item information of the user corresponding to the customer from the corresponding web service server 5. The user-correlated information processing unit 3002 also refers to the customer information DB 306 and acquires the purchase history of the customer stored in the customer information DB 306. The DB item information and the purchase history acquired by the user-correlated information processing unit 3002 may be limited to a period, for example, the past one year or the like.

The user-correlated information processing unit 3002 extracts the taste and preference information of the customer, based on the DB item information acquired from the web service server 5 and the purchase history acquired from the customer information DB 306.

The user-correlated information processing unit 3002 accesses the web service server 5 if the personal information use enable-disable flag of the customer stored in the customer information DB 306 is in the ON-state. The user-correlated information processing unit 3002 suppresses access to the web service server 5 if the personal information use enable-disable flag is in the OFF-state.

The generation processing unit 3003 is an example of a derivation unit and a presentation unit. The generation processing unit 3003 derives a merchandise item to be suggested to the customer from the sales promotion text generated by the clothing item suggestion LLM 309, based on the information about the merchandise item purchased by the customer acquired by the user-correlated information processing unit 3002.

Specifically, the generation processing unit 3003 generates an input including sentence the taste and preference information of the customer extracted based on the information about the clothing item purchased by the customer or the clothing item which the customer is interested in, acquired by the user-correlated information processing unit 3002, the purchase history of the customer, and the instruction information giving an instruction to generate a sales promotion text.

The generation processing unit 3003 inputs the generated input sentence to the clothing item suggestion LLM 309 and thus causes the clothing item suggestion LLM 309 to generate a sales promotion text presenting a merchandise item which the customer is recommended to purchase. As the clothing item suggestion LLM 309 generates a sales promotion text, the generation processing unit 3003 acquires the sales promotion text. Subsequently, the generation processing unit 3003 calculates the degree of similarity between the clothing item described in the sales promotion text and the merchandise items stored in the merchandise master 308, and extracts a plurality of merchandise items with a degree of similarity higher than a predetermined degree of similarity, from the merchandise master 308.

As the method for calculating the degree of similarity between the clothing item described in the sales promotion text and the merchandise items stored in the merchandise master 308, a known and available technique may be used. For example, the degree of similarity may be calculated in the form of the matching rate of words and phrases between the description of the clothing item in the sales promotion text and the merchandise description of the merchandise items stored in the merchandise master 308. Also, for example, the merchandise description of the merchandise items stored in the merchandise master 308 may be vectorized and thus stored, using a commonly used method of natural language processing, and the degree of similarity may be calculated in the form of the degree of cosine similarity to the sentence described in the vectorized sales promotion text.

The generation processing unit 3003 generates a suggested clothing item list in which the merchandise items extracted from the merchandise master 308 and the merchandise information of the merchandise items are correlated with each other. Subsequently, the generation processing unit 3003 transmits the generated suggested clothing item list to the mirror signage 2.

The suggested clothing item list is a list including each of a plurality of merchandise items extracted from the merchandise master 308. The merchandise items in the suggested clothing item list are merchandise items correlated with the sales promotion text generated by the clothing item suggestion LLM 309, based on the information about the merchandise item purchased by the customer, and therefore are merchandise items reflecting the taste and preference information of the customer, among the merchandise items stored in the merchandise master 308.

The customer guide processing unit 3004 is an example of an output unit and a management unit. The customer guide processing unit 3004 outputs, to the store clerk terminal 4, information about the customer service support for the merchandise item selected by the customer from among the merchandise items derived by the generation processing unit 3003.

Specifically, upon receiving the merchandise information of the merchandise item selected by the customer via the operation unit 209 of the mirror signage 2, the customer guide processing unit 3004 refers to the fitting room information in the fitting room management DB 307, selects one fitting room whose state is “0”, that is, a vacant fitting room, and changes the state of the selected fitting room to “1”, that is, the state of being in use. The method for selecting a vacant fitting room is not particularly limited and may be selected, based on a predetermined rule. For example, the customer guide processing unit 3004 may select a fitting room in ascending order of fitting room number. Also, for example, the customer guide processing unit 3004 may select a fitting room in order from fitting room with the longest vacancy.

Subsequently, the customer guide processing unit 3004 acquires the fitting room number of the fitting room whose state is changed, from the fitting room management DB 307, and transmits the received merchandise information of the merchandise item and the acquired fitting room number to the store clerk terminal 4.

If the fitting room information stored in the fitting room management DB 307 shows that the states of all the fitting rooms are “1”, that is, in the state of being in use, the customer guide processing unit 3004 executes, for example, the following processing. First, the customer guide processing unit 3004 transmits, to the store clerk terminal 4, a message reporting that there is a customer who wants to try an item on or that there is no vacant fitting room. At this point, the customer guide processing unit 3004 may also report information that can specify the currently serving mirror signage 2, the location information of the mirror signage 2, and the like. The customer guide processing unit 3004 also transmits, to the mirror signage 2, a message notifying that a store clerk will come to help the customer and that the customer should wait until the store clerk arrives. Upon receiving the message, the display control unit 2002 of the mirror signage 2 causes the display unit 208 to display the message and thus reports to the customer.

Upon receiving the fitting room number and the merchandise information, the store clerk terminal 4 displays the fitting room number and the merchandise information thus received, on a display unit of the store clerk terminal 4, not illustrated. The store clerk checking the fitting room number and the merchandise information displayed on the display unit of the store clerk terminal 4 prepares the merchandise item corresponding to the merchandise information in the fitting room corresponding to the fitting room number and subsequently gives the store clerk terminal 4 an indication that the preparation of the fitting room is completed, from an operation unit, not illustrated, of the store clerk terminal 4. Upon accepting the indication, the store clerk terminal 4 transmits a preparation completion notification to the store server 3.

Upon receiving the preparation completion notification from the store clerk terminal 4, the customer guide processing unit 3004 of the store server 3 transmits the fitting room number included in the preparation completion notification to the mirror signage 2.

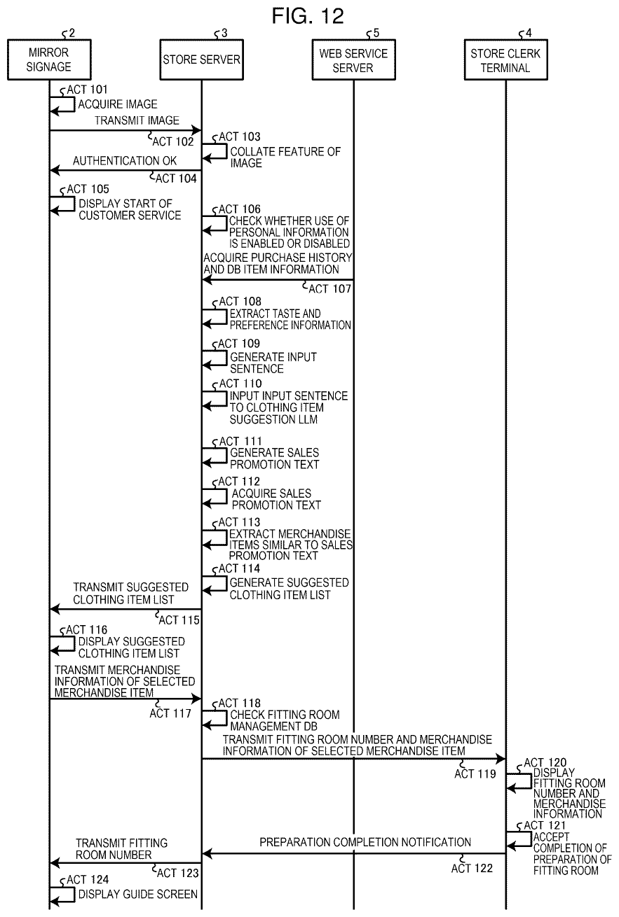

The control processing of the customer service support system 1 will now be described with reference to FIG. 12. FIG. 12 is a sequence chart showing an example of the control processing of the customer service support system 1 according to the embodiment. The sequence chart shown in FIG. 12 shows an example of processing in the case of performing the clothing item suggestion processing after performing the authentication processing of a customer.

First, the authentication unit 2001 of the mirror signage 2 acquires a customer image of a customer visiting the store, via the image pickup unit 210 (ACT 101). Upon acquiring the customer image, the authentication unit 2001 transmits the acquired customer image to the store server 3 (ACT 102).

The authentication processing unit 3001 of the store server 3 extracts a feature from the customer image received from the authentication unit 2001 and collates the extracted feature with the feature data stored in the customer information DB 306 (ACT 103). If the feature extracted from the customer image matches the feature data of any customer stored in the customer information DB 306, the authentication processing unit 3001 transmits an authentication processing completion notification to the mirror signage 2 (ACT 104).

Upon receiving the authentication processing completion notification from the authentication processing unit 3001, the display control unit 2002 of the mirror signage 2 causes the display unit 208 of the mirror signage 2 to display a message notifying of the start of the customer service (ACT 105).

Meanwhile, the user-correlated information processing unit 3002 of the store server 3 determines the value of the personal information use enable-disable flag of the customer specified by the authentication processing unit 3001 from the customer information DB 306 (ACT 106). If the flag is in the ON-state, the user-correlated information processing unit 3002 accesses the closet database link of the customer stored in the customer information DB 306 and acquires the DB item information of the user corresponding to the customer from the corresponding web service server 5. The user-correlated information processing unit 3002 also refers to the customer information DB 306 and acquires the purchase history of the customer stored in the customer information DB 306 (ACT 107). Subsequently, the user-correlated information processing unit 3002 extracts the taste and preference information of the customer, based on the DB item information acquired from the web service server 5 and the purchase history acquired from the customer information DB 306 (ACT 108).

Subsequently, the generation processing unit 3003 of the store server 3 generates an input sentence including the taste and preference information of the customer extracted based on the information about the clothing item purchased by the customer or the clothing item which the customer is interested in, acquired from the user-correlated information processing unit 3002, the purchase history of the customer, and instruction information giving an instruction to generate a sales promotion text (ACT 109). Subsequently, the generation processing unit 3003 inputs the generated input sentence to the clothing item suggestion LLM 309 (ACT 110) and causes the clothing item suggestion LLM 309 to generate a sales promotion text that presents a merchandise item to be suggested to the customer (ACT 111).

As the clothing item suggestion LLM 309 generates the sales promotion text, the generation processing unit 3003 of the store server 3 acquires this sales promotion text (ACT 112). Subsequently, the generation processing unit 3003 calculates the degree of similarity between the clothing item described in the sales promotion text and the merchandise items stored in the merchandise master 308 and extracts a plurality of merchandise items with a degree of similarity higher than a predetermined degree of similarity, from the merchandise master 308 (ACT 113). Subsequently, the generation processing unit 3003 generates a suggested clothing item list in which the merchandise items extracted from the merchandise master 308 and the merchandise information of the merchandise items are correlated with each other (ACT 114). Subsequently, the generation processing unit 3003 transmits the generated suggested clothing item list to the mirror signage 2 (ACT 115).

Upon receiving the suggested clothing item list from the generation processing unit 3003, the display control unit 2002 of the mirror signage 2 causes the display unit 208 to display a screen showing the suggested clothing item list (ACT 116). Then, upon accepting a selection operation in the suggested clothing item list via the operation unit 209, the display control unit 2002 transmits the merchandise information of the selected merchandise item to the store server 3 (ACT 117).

Upon receiving the merchandise information of the merchandise item selected by the customer via the operation unit 209 of the mirror signage 2, the customer guide processing unit 3004 of the store server 3 refers to the fitting room information in the fitting room management DB 307 and selects one fitting room in the state of “0”, that is, a vacant fitting room, based on a predetermined rule, for example, determining the state of the fitting room in ascending order of fitting room number, or the like, and changes the state of the selected fitting room to “1”, that is, the state of being in use (ACT 118). Subsequently, the customer guide processing unit 3004 acquires the fitting room number of the fitting room whose state is changed, from the fitting room management DB 307, and transmits the received merchandise information of the merchandise item and the acquired fitting room number to the store clerk terminal 4 (ACT 119).

Upon receiving the fitting room number and the merchandise information, the store clerk terminal 4 displays the fitting room number and the merchandise information thus received, on the display unit of the store clerk terminal 4, not illustrated (ACT 120). The store clerk checking the fitting room number and the merchandise information displayed on the display unit of the store clerk terminal 4 prepares the merchandise item corresponding to the merchandise information in the fitting room corresponding to the fitting room number and subsequently gives the store clerk terminal 4 an indication that the preparation of the fitting room is completed, from the operation unit, not illustrated, of the store clerk terminal 4. Upon accepting the indication (ACT 121), the store clerk terminal 4 transmits a preparation completion notification to the store server 3 (ACT 122).

Subsequently, upon receiving the preparation completion notification from the store clerk terminal 4, the customer guide processing unit 3004 of the store server 3 transmits the fitting room number included in the preparation completion notification to the mirror signage 2 (ACT 123). Then, upon receiving the fitting room number from the store server 3, the display control unit 2002 of the mirror signage 2 causes the display unit 208 to display the fitting room guide screen Gc (ACT 124).

As described above, by the foregoing processing, the customer service support system 1 can perform the customer service about a suggested merchandise item to the customer, in place of the store clerk, and can hand over the customer service operation to the store clerk at the stage of fitting. Therefore, even if the store clerk finds it difficult to secure a sufficient service time for the customer, a personalized customer service experience can be provided for the customer.

If the feature extracted from the customer image does not match the feature data of any customer stored in the customer information DB 306 in ACT 104, the authentication processing unit 3001 may transmit, to the mirror signage 2, a message notifying that the authentication processing is not completed normally. Then, upon receiving the message notifying that the authentication processing is not completed normally, the display control unit 2002 may cause the display unit 208 to display this message and may return the processing to ACT 101.

Also, if the personal information use enable-disable flag of the customer specified by the authentication processing unit 3001 from the customer information DB 306 is in the OFF-state in ACT 106, the user-correlated information processing unit 3002 may acquire the merchandise information of a merchandise item for the store to recommend to the customer due to the store having a sale or the like, from the merchandise master 308, instead of acquiring the user-correlated information from the web service server 5. The user-correlated information processing unit 3002 may also transmit, to the mirror signage 2, a message that prompts the customer to agree to the use of the personal information. In this case, upon receiving the message, the display control unit 2002 causes the display unit 208 to display the message in a selectable format via the operation unit 209. If the customer agrees to the use of the personal information via the operation unit 209, the display control unit 2002 transmits, to the store server 3, a message to the effect that the customer agrees to the use of the personal information. Then, upon receiving the message, the user-correlated information processing unit 3002 changes the personal information use enable-disable flag to the ON-state and advances the processing to ACT 107.

Also, preferably, in ACT 116, when the clothing item selection screen Gb is displayed, the display control unit 2002 of the mirror signage 2 may cause the display unit 208 to display a message such as “You can try on merchandise items in the suggested clothing item list”. Also, preferably, in ACT 117, after the merchandise information of the selected merchandise item is transmitted to the store server 3, the display control unit 2002 may cause the display unit 208 to display a message such as “Please wait as we prepare the merchandise item and the fitting room”.

As described above, in the customer service support system 1 according to the embodiment, the mirror signage 2 specifies a customer visiting the store in cooperation with the store server 3. The store server 3 acquires the user-correlated information of the specified customer from the web service server 5. The store server 3 derives a merchandise item to be suggested to the customer, based on the acquired information about the merchandise item purchased by the customer and instruction information giving an instruction to suggest the merchandise item. The store server 3 also suggests the derived merchandise item in a selectable state to the customer via the mirror signage 2. Also, with respect to the merchandise item selected by the customer from among the suggested merchandise items, the store server 3 outputs the fitting room number and the merchandise information of the selected merchandise item to the store clerk terminal 4.

Thus, in the customer service support system 1 according to this embodiment, since a sales promotion text is generated based on the information about a merchandise item purchased by the customer, processing that reflects the characteristics of the customer can be performed. Also, the customer service support system 1 enables the customer to make a request to the store clerk for the fitting of the merchandise item selected by the customer from among the merchandise items presented via the mirror signage 2. Also, the customer service support system 1 of the embodiment can perform the customer service about a suggested merchandise item to the customer, in place of the store clerk, and can hand over the customer service operation to the store clerk at the stage of fitting. Therefore, even if the store clerk finds it difficult to secure a sufficient service time for the customer, a personalized customer service experience can be provided for the customer. Thus, the customer service support system 1 of the embodiment can achieve improvement in customer service experience without human intervention.

The above embodiment can be implemented with a suitable modification by changing a part of the configurations or functions of each of the above devices. In the description below, some modification examples according to the above embodiment are described as other embodiments. In the description below, differences from the above embodiment are mainly described and the same matters as the already described contents are not described in detail. The modification examples described below may be implemented separately or may be combined where appropriate.

### Modification Example 1

In ACT 122 in FIG. 12, the preparation completion notification is given from the store clerk terminal 4 to the store server 3. However, this is not limiting. Instead of giving the preparation completion notification from the store clerk terminal 4, a configuration where a similar notification is given from the mirror signage 2, not illustrated, that is installed in the fitting room, may be employed. With this configuration, the customer can be guided to the fitting room after the store clerk makes sure that the securing of the fitting room and the securing of the merchandise item selected by the customer are complete.

### Modification Example 2

In ACT 113 in FIG. 12, the generation processing unit 3003 calculates the degree of similarity between the clothing item described in the sales promotion text and the merchandise items stored in the merchandise master 308, and extracts a plurality of merchandise items with a degree of similarity higher than the predetermined degree of similarity from the merchandise master 308. However, this is not limiting. A configuration where the generation processing unit 3003 extracts a plurality of merchandise items with a degree of similarity lower than the predetermined degree of similarity from the merchandise master 308 may be employed. With this configuration, the customer can be recommended to purchase a merchandise item that is not similar to the merchandise item purchased by the customer, that is, the merchandise item already owned by the customer. Therefore, the customer's appetite for purchase is promoted and the effect of improving the customer service experience can be more expected.

The program executed by the customer service support system 1 according to the embodiment and the modification examples may be configured to be stored in a computer connected to a network such as the internet and then downloaded via the network and thus provided. Also, the program executed by the customer service support system 1 according to the embodiment and the modification examples may be configured to be provided or distributed via a network such as the internet.

The program executed by each device in the above embodiment is provided in the state of being incorporated in advance in the ROM, the memory unit or the like. The program executed by each device in the above embodiment may be configured to be recorded as a file in an installable format or an executable format in a computer-readable recording medium such as a CD-ROM, a flexible disk (FD), a CD-R, or a digital versatile disk (DVD), and provided in this state.

Also, the program executed by each device in the above embodiment may be configured to be stored in a computer connected to a network such as the internet and then downloaded via the network and thus provided. Also, the program executed by each device in the above embodiment may be configured to be provided or distributed via a network such as the internet.

While an embodiment of the present disclosure has been described, this embodiment has been presented by way of example only, and is not intended to limit the scope of the disclosure. Indeed, the novel embodiment and the modification examples thereof described herein may be embodied in a variety of other forms; furthermore, various omissions, substitutions, changes and combinations in the form of the embodiment described herein may be made without departing from the spirit of the disclosure. The accompanying claims and their equivalents are intended to cover such forms or modifications as would fall within the scope and spirit of the disclosure.

What is claimed is:

1. An information processing device, comprising:
a specifying component configured to specify a customer visiting a store;
an acquisition component configured to acquire information relating to a purchased merchandise item of the customer specified by the specifying component from a memory device storing information relating to a purchased merchandise item purchased by each customer in the past;
a derivation component configured to derive a suggested merchandise item to be suggested to the customer from among merchandise items available for sale at the store, based on the information about the purchased merchandise item acquired by the acquisition component;
a presentation component configured to present the suggested merchandise item derived by the derivation component in a selectable state to the customer via a display device provided at the store; and
an output component configured to, upon accepting a selection of a merchandise item from among the suggested merchandise items, output information about the selected merchandise item to a terminal carried by a store clerk.

2. The information processing device according to claim 1, further comprising:
a management component configured to manage a state of each fitting room provided in the store, wherein
the output component, upon accepting a selection of a merchandise item from among the suggested merchandise items, outputs information about the selected merchandise item and information indicating a vacant fitting room to the terminal.

3. The information processing device according to claim 2, wherein
the management component changes a state of the fitting room indicated by the output component from a vacant state to a state of being in use.

4. The information processing device according to claim 2, wherein
the presentation component presents information indicating a location of the fitting room to the customer when notified by the terminal that preparation of the fitting room is completed.

5. The information processing device according to claim 1, further comprising:
an extraction component configured to extract preference information representing a preference of the customer, based on the information relating to the purchased merchandise item of the customer acquired by the acquisition component, wherein
the derivation component derives a merchandise item to be suggested to the customer, based on the preference information.

6. The information processing device according to claim 5, wherein
preference information comprises items in a category of previously purchased merchandise items of the customer.

7. The information processing device according to claim 1, wherein
information relating to the purchased merchandise includes at least one of color information, size information, and brand information of a clothing item.

8. An information processing method, comprising:
specifying a customer visiting a store;
acquiring information relating to a purchased merchandise item of the specified customer from a memory device storing information relating to a purchased merchandise item purchased by each customer in the past;
deriving a suggested merchandise item to be suggested to the customer from among merchandise items available for sale at the store, based on the acquired information relating to the purchased merchandise item;
presenting the derived suggested merchandise item in a selectable state to the customer via a display device provided at the store; and
upon accepting a selection of a merchandise item from among the suggested merchandise items, outputting information relating to the selected merchandise item to a terminal carried by a store clerk.

9. The information processing method according to claim 8, further comprising:
managing a state of each fitting room provided in the store; and
upon accepting a selection of a merchandise item from among the suggested merchandise items, outputting information about the selected merchandise item and information indicating a vacant fitting room to the terminal.

10. The information processing method according to claim 9, further comprising:
changing a state of the fitting room indicated by the outputting from a vacant state to a state of being in use.

11. The information processing method according to claim 9, further comprising:
presenting information indicating a location of the fitting room to the customer when notified by the terminal that preparation of the fitting room is completed.

12. The information processing method according to claim 8, further comprising:
extracting preference information representing a preference of the customer, based on the information relating to the purchased merchandise item of the customer acquired; and
deriving a merchandise item to be suggested to the customer, based on the preference information.

13. The information processing method according to claim 12, wherein
preference information comprises items in a category of previously purchased merchandise items of the customer.

14. The information processing method according to claim 8, wherein
information relating to the purchased merchandise includes at least one of color information, size information, and brand information of a clothing item.

15. A retail store shopping assistant device, comprising:
a specifying component configured to specify a customer visiting a store;
an acquisition component configured to acquire information relating to a purchased merchandise item of the customer specified by the specifying component from a memory device storing relating information to a purchased merchandise item purchased by each customer in the past;
a derivation component configured to derive a suggested merchandise item to be suggested to the customer from among merchandise items available for sale at the store, based on the information about the purchased merchandise item acquired by the acquisition component;
a presentation component configured to present the suggested merchandise item derived by the derivation component in a selectable state to the customer via a display device provided at the store; and
an output component configured to, upon accepting a selection of a merchandise item from among the suggested merchandise items, output information about the selected merchandise item to a terminal carried by a store clerk.

16. The retail store shopping assistant device according to claim 15, further comprising:
a management component configured to manage a state of each fitting room provided in the store, wherein
the output component, upon accepting a selection of a merchandise item from among the suggested merchandise items, outputs information about the selected merchandise item and information indicating a vacant fitting room to the terminal.

17. The retail store shopping assistant device according to claim 16, wherein
the management component changes a state of the fitting room indicated by the output component from a vacant state to a state of being in use.

18. The retail store shopping assistant device according to claim 16, wherein
the presentation component presents information indicating a location of the fitting room to the customer when notified by the terminal that preparation of the fitting room is completed.

19. The retail store shopping assistant device according to claim 15, further comprising:
an extraction component configured to extract preference information representing a preference of the customer, based on the information relating to the purchased merchandise item of the customer acquired by the acquisition component, wherein
the derivation component derives a merchandise item to be suggested to the customer, based on the preference information.
